(19) United States
(12) Patent Application Publication
(10) Pub. No.: US 2011/0303656 A1
(43) Pub. Date: Dec. 15, 2011

(54) FOOD STORAGE BAG HOLDER

(76) Inventors: Carol Blodgett, JR., Jacksonville, FL (US); Kara Anderson, JR., Jacksonville, LA (US)

(21) Appl. No.: 13/217,374

(22) Filed: Aug. 25, 2011

Related U.S. Application Data
(63) Continuation-in-part of application No. 11/674,257, filed on Feb. 13, 2007, now abandoned.
(60) Provisional application No. 60/773,295, filed on Feb. 14, 2006.

(51) Int. Cl. H05B 6/80; H05B 6/64

(52) U.S. Cl. 219/725; 219/678

(57) ABSTRACT

A food storage bag holder is configured to maintain a food storage bag in an open and upright configuration to facilitate filling a food storage bag with contents such as food. The holder has a body comprised of a cylinder or frame with a top rim adapted to frictionally engage a folded over top edge of the food storage bag to support it and hold it open. The body defines an interior cavity. The holder is sized to engage a food storage bag. The top rim is sized to engage a bag having a resealable closure. The bag is engaged by inserting the bag into the cavity defined by the body and folding the closure of the bag over the top rim of the holder. The top rim has an outer perimeter less than the perimeter of the mouth of the bag. The height h of the holder is less than the height measured from the bottom of the body of the bag to the bottom edge of the closure of the bag.

### RELATED APPLICATION

This application is a continuation in part and claims the benefit of priority of U.S. nonprovisional application Ser. No. 11/674,257, filed Feb. 13, 2007, the entire contents of which are incorporated herein by this reference, which claims the benefit of priority of U.S. provisional application 60/773,295, filed Feb. 14, 2006, the entire contents of which are incorporated herein by this reference.

### FIELD OF THE INVENTION

This invention generally relates to zipper storage bags, and more particularly, to a food storage bag holder and method configured to maintain the bag in an open upright configuration to facilitate filling the bag with contents such as food for storage and to facilitate cooking of the contents in an ordinary food storage bag without melting the bag.

### BACKGROUND

Reclosable thermoplastic bags are commonly used in food storage. The bags are generally made out of a plastic film and have two side walls that are folded at the bottom, sealed at the sides and open at the top. The bags typically have a resealable fastener at the top of the bag, such as, for , an adhesive, a wire tie, or a plastic zipper, such as those sold under the brand name ZIPLOC® storage bags from the S. C. Johnson Company. Such bags are useful for storing various food items, including leftovers, ingredients for a meal, etc . . . When properly closed, such bags provide and an airtight seal that is suitable for maintaining freshness. They are also relatively inexpensive, versatile and convenient to use. They may be used to store various amounts of solid and/or liquid foods. After use, dirty bags may be discarded.

However, such conventional storage bags are not without drawbacks. In particular, because such bags are non-rigid pliant structures, they are difficult to maintain in an erect wide-open configuration. If an assistant is available, he or she may lend helping hands to keep the bag erect and the mouth of the bag wide open while the food handler places or pours the food contents into the open bag. Unfortunately, an assistant is not always available. Left unsupported, a bag tends to collapse while its mouth tends to close. This tendency makes guiding food into the bag a very difficult task, often resulting in spillage.

Another problem with such bags is melting. Such bags are typically made from polyethylene plastic with a melting point of approximately 195° F. They are not designed or approved to withstand the heat of boiling water or microwave cooking

What is needed is an aesthetically pleasing, easy to use, device and corresponding methodology configured to effectively addresses the unique challenges of handling a wide variety of food storage bags, including, among other things, holding and supporting the bag upright, maintaining the mouth of the bag in a fully open position, to facilitate guiding material into the bag so that spillage may be minimized and to enable microwave cooking in the bag without melting. The invention is directed to overcoming one or more of the problems and solving one or more of the needs as set forth above.

### SUMMARY OF THE INVENTION

To solve one or more of the problems set forth above, in an exemplary implementation of the invention, a method of reheating food in a food storage bag is provided. The method includes steps of providing a bag holder configured to maintain the food storage bag in an open and upright configuration. The holder includes a container having an open top and a closed bottom. The open top has a top rim adapted to frictionally engage a folded over top edge of the food storage bag to support it and hold it open. The container also has an interior cavity. The holder is sized to engage the food storage bag. A determined amount of a liquid medium is introduced into the holder. The food storage bag is inserted in an open and upright configuration into the holder. The food storage bag has a top edge and contains food to be reheated. The top edge of the food storage bag is extended above the top rim of the holder and folded over the top rim of the holder. The holder containing the liquid medium and the food storage bag and food is placed in a microwave oven, which is activated to reheat the food. The liquid medium may be water, water and a liquid with a lower boiling point than water, water and ethanol, a cup of water, or some other liquid medium suitable for thermal regulation during microwave heating. The microwave oven may reheat the food without boiling the liquid and without melting the food storage bag. The bag holder and the food storage bag are transparent. Thus, the food and liquid may be observed while the microwave oven reheats the food.

A system for reheating food in a food storage bag in a microwave oven is also provided. The system includes a bag holder configured to maintain the food storage bag in an open and upright configuration. The holder includes a container having an open top and a closed bottom. The open top has a top rim adapted to frictionally engage a folded over top edge of the food storage bag to support it and hold it open. The container further has an interior cavity and the holder being sized to engage the food storage bag. The food storage bag has a body, a bottom, a top, a resealable closure with a top edge and a bottom edge attached to the top of the body of the bag, and a height measured from the bottom of the body of the bag to the bottom edge of the resealable closure. A determined amount of a liquid medium is contained in the holder. The food storage bag is inserted in an open and upright configuration into the holder in the liquid medium. The top edge of the food storage bag is folded over the top rim of the holder, and the bottom of the food storage bag rests on the closed bottom of the bag holder. A microwave oven reheats the food.

### BRIEF DESCRIPTION OF THE DRAWINGS

The foregoing and other aspects, objects, features and advantages of the invention will become better understood with reference to the following description, appended claims, and accompanying drawings, where:

FIG. 1 shows a perspective view of a cup-like holder for a food storage bag according to principles of the invention; and

FIG. 2 shows a side view of a cup-like holder for a food storage bag according to principles of the invention; and

FIG. 3 shows a perspective view of a cup-like holder with an engaged food storage bag according to principles of the invention; and

FIG. 4 shows a perspective view of a section of a cup-like holder with an engaged food storage bag according to principles of the invention; and

FIG. 5 shows a plan view of an exemplary food storage bag for use with a holder according to principles of the invention; and

FIG. 6 provides a high level flowchart showing steps of a method of using a holder according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the shapes, relative sizes, ornamental aspects, proportions or steps shown in the figures.

### DETAILED DESCRIPTION

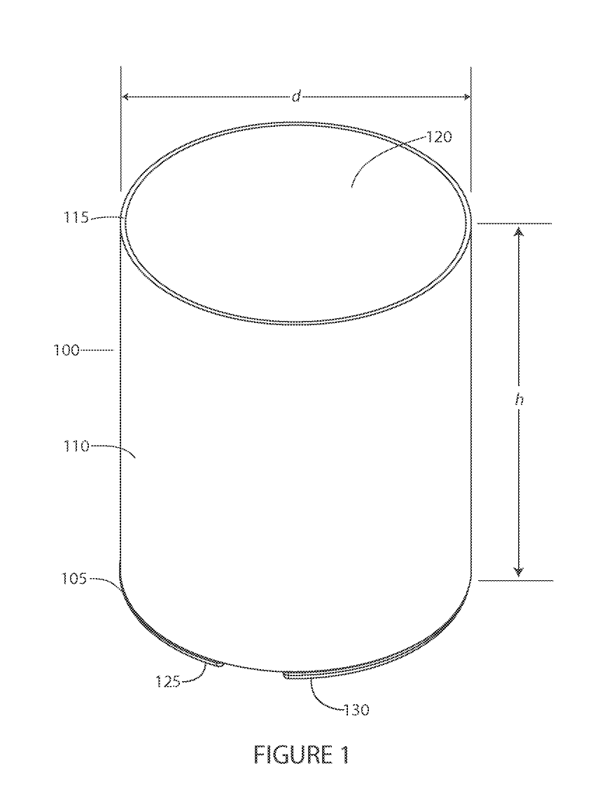

Referring to the Figures, in which like parts are indicated with the same reference numerals, an exemplary bag holder configured to effectively addresses the unique challenges of handling a wide variety of food storage bags, including, among other things, holding and supporting the bag upright (i.e., erect), maintaining the mouth of the bag in a fully open position, to facilitate guiding material into the bag so that spillage may be minimized, and holding a liquid medium for thermal regulation during microwave heating. In FIG. 1, a perspective view of a cup-like holder 100 for a food storage bag according to principles of the invention is shown. The exemplary holder 100 is configured to hold the mouth of a bag open while the bag is being filled. The holder 100 includes a cylindrical body 110 with a top rim 115 adapted to frictionally engage a folded over top edge of a bag to support it and hold it open. A solid bottom 105 prevents leakage of contents of the holder 100. The space 120 defined by the interior of the cylindrical body 110 provides a compartment for storing bagged food and a liquid medium. Bottom rims, other protrusions or feet 125, 130 are optionally provided to support and elevate the bottom 105 of the holder, while resisting slipping.

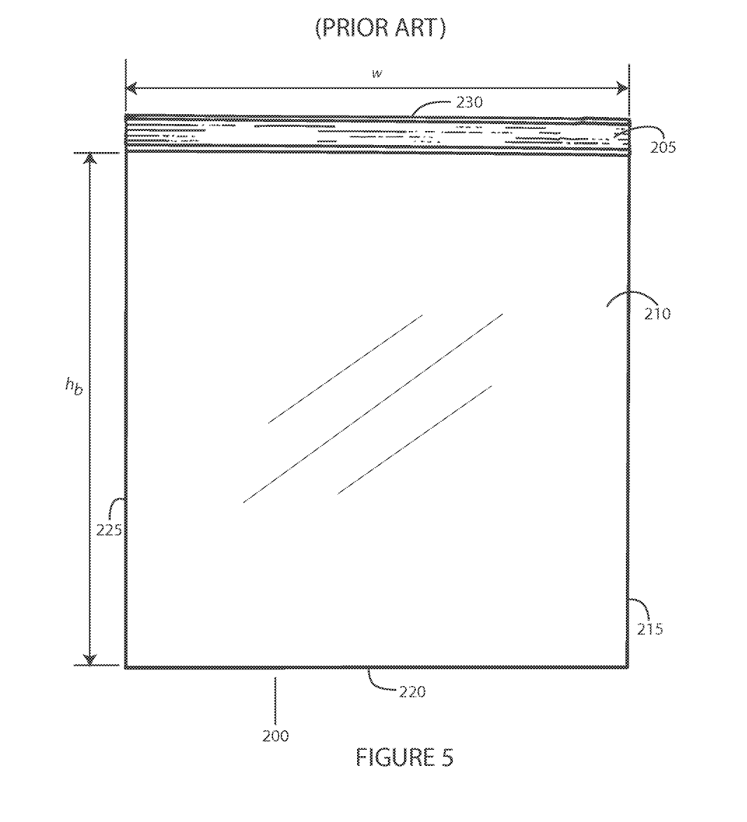

The holder 100 is configured to engage a food storage bag, such as the exemplary bag as shown in FIG. 5. The bag 200 is generally made out of a plastic film and has two side walls 210 that are folded at the bottom 220, sealed at the sides 215, 225 and having a zipper closure 205 at the top 230, also known as the mouth of the bag 200.

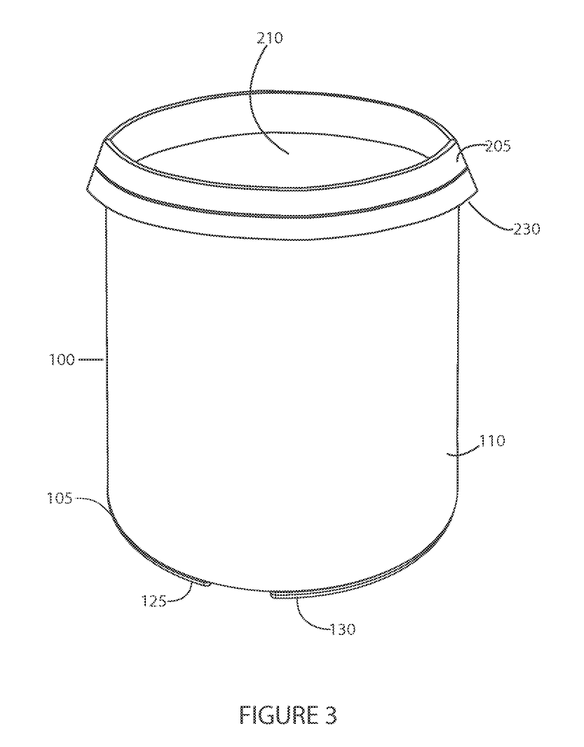

The holder 100 is sized to engage a food storage bag, such as the exemplary bag as shown in FIG. 5. The bag 200 is engaged on the holder 100 by inserting the body 210 of the bag 200 into the cavity 120 defined by the cylindrical body 110 of the holder 100, and folding the closure 205 of the bag 200 over the rim 115 of the holder, as conceptually illustrated in FIG. 3. Thus, the outer perimeter of the rim 115 (i.e., d×π) of the cup-like holder 100 should be slightly less (e.g., 75% to 99%, and more preferably 90% to 95%) than the perimeter of the mouth of the bag (i.e., 2×w). Therefore, the diameter d of the cup-like holder should be slightly less than the perimeter of the mouth of the bag (i.e., 2×w) divided by π. Additionally, when the bag 200 is engaged on the holder 100, the bottom 220 of the bag 200 preferably rests at the bottom of the holder 100. Thus, the weight of the contents of the bag 200 is supported in large part by the bottom 220 of the holder 100. The height h of the cup-like holder 100 should be slightly less than the height h_{b} of the bag 200, as measured from the bottom 220 of the bag 200 to the bottom of the closure 205.

The base 105 is provided to cover the bottom of the cylinder 110. The base provides a support surface for an engaged bag 200 and its contents. The base 105 and cylindrical body 110 form a cup, which is suitable for containing any contents that may leak from a punctured or defective bag 200. Thus, the base helps isolate such messes to the area within the cup.

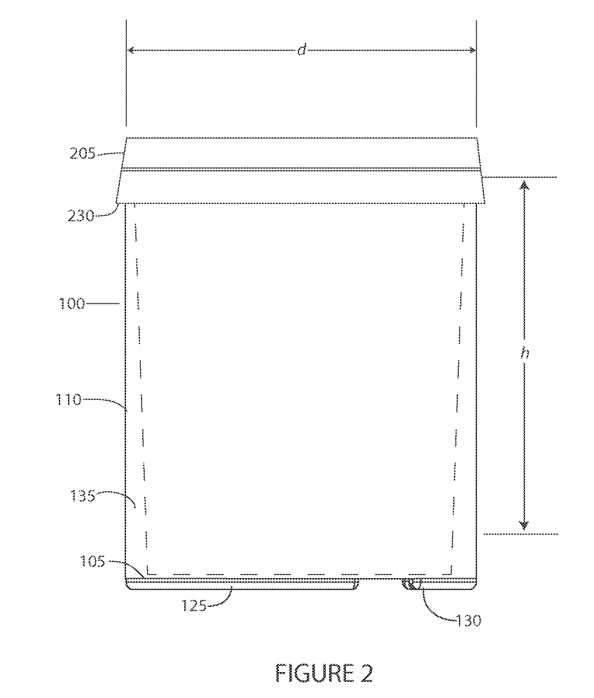

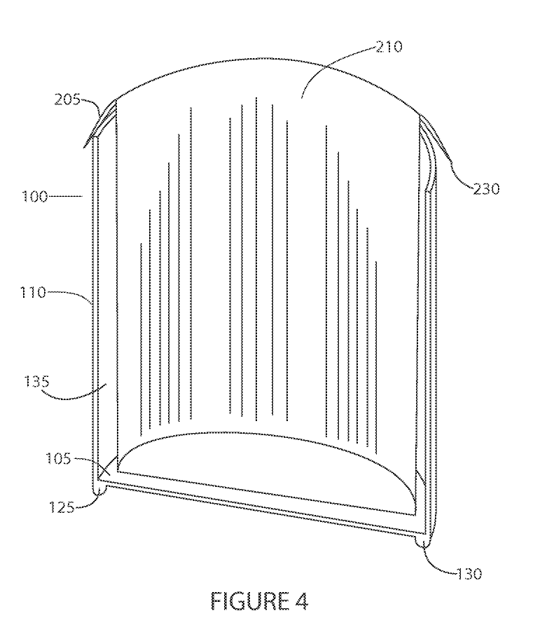

Referring now to FIG. 2, a side view of a holder 100 containing a food storage bag 200 is shown. The bag 200 is engaged on the holder 100 by inserting the body 210 of the bag 200 into the cavity 120 defined by the cylindrical body 110 of the holder 100, and folding the closure 205 of the bag 200 over the rim 115 of the holder 100. Space 135 exists between the contained bag 200 and the holder 100. This space is filled or at least partially filled with a liquid during microwave use, as discussed below. A portion of the bag 200 within the holder 100 is also shown in the cutaway view of FIG. 4.

A bag holder in accordance with the invention preferably insures that the perimeter of the bag opening is preferably not torn during the processes of mounting a new bag. In order to accomplish this, the invention utilizes no hooks to tear the bag and no clips to concentrate stress at limited areas, which can also tear the bag.

A bag holder in accordance with the invention also protects the bag against tearing during the act of adding contents to the bag. The body of the holder (e.g., cylindrical body 110) accomplishes this by providing protection for the bag over its full periphery.

While the exemplary holder 100 is shown with a cylindrical shaped body 110, the holder is not limited to such shape. Rather, other non-circular cross sectional shapes (e.g., rectangular, square, polygonal) may be used without departing from the scope of the invention.

The holder 100 may be comprised of various materials, such as metal and/or plastic. By way of and not limitation, aluminum, steel, alloys thereof or other metallic materials conventionally used for manufacturing kitchen tools may be utilized. Such materials may be plated, coated or otherwise finished to provide a decorative, aesthetic pleasing and/or corrosion resistant finish for the apparatus.

In another exemplary implementation, the holder 100 is comprised of a rigid plastic or polymeric material, such as polyvinyl chloride (PVC), polyethylene, polypropylene, polystyrene, acrylics, cellulosics, acrylonitrile-butadiene-styrene terpolymers, urethanes, thermo-plastic resins, thermo-plastic elastomers (TPE), acetal resins, polyamides, polycarbonates and polyesters. While many other materials may be used alone or in combination with the aforementioned materials and/or other materials, without departing from the scope of the present invention, preferably the material is relatively inexpensive, easy to use in manufacturing operations and results in an aesthetically acceptable, durable, water resistant product. The material may further include additives to provide desired properties such as desired colors, structural characteristics, glow-in-the dark properties and thermal reactivity (e.g., color changes according to heat).

In one embodiment, the holder 100 is comprised of a transparent or translucent material. Transparency (or translucency) allows a user to visualize the contents of the bag 200 and the level to which the bag 200 is filled. Nonlimiting examples of transparent plastics include polycarbonate, acrylic, nylon, ABS, PVC, polyester, and polyurethane in certain formulations.

In an exemplary embodiment, the holder is comprised of microwave-safe plastic. Bagged food may be cooked in the opened bag in the holder within a microwave.

The plastic holder 100 may optionally be formulated to change color when it reaches a predetermined or higher temperature. This can be accomplished by mixing a thermochromic additive to the base material in an amount that is sufficient to achieve a desired color changing range. As an , a mixture of approximately 5% to 30% (pbw) of Matsui International Co., Inc.'s Chromicolor® concentrate may be introduced to provide a plastic structure that visibly changes color at a determined elevated temperature, such as approximately 190° F., which is slightly lower than the melting point of plastics comprising food storage bags.

Alternatively, a photochromic additive may be added to a plastic base material in an amount that is effective to achieve a desired color change when the base 100 is exposed to certain lighting conditions. As an , a mixture of approximately 5% to 35% (pbw) of Matsui International Co., Inc.'s Photopia® additive may be introduced to plastic base material, to provide a plastic structure that visibly changes color in the presence of sunlight or ultraviolet light.

As another alternative, phosphorescent polymer additives, such as aluminate based phosphors, may be added to adsorb light energy and continue to release that energy as visible light after the energy source is removed. Advantageously, such an embodiment provides a holder that is easy to locate in darkened conditions.

The base 100 may be produced using any suitable manufacturing techniques known in the art for the chosen material, such as (for ) milling, casting, stamping and machining in the case of a metal base, and injection, compression, structural foam, blow, or transfer molding; polyurethane foam processing techniques; vacuum forming; and casting, in the case of a plastic base. Preferably, the manufacturing technique is suitable for mass production at relatively low cost per unit, and results in an aesthetically acceptable product with a consistent acceptable quality.

Those skilled in the art will appreciate that the invention is not limited to use with any particular size bag. The holder may be configured and sized to hold any commercially available food storage bag. Proper configuration and sizing is important to the invention. By way of and not limitation, a holder according to principles of the invention may be configured and sized to engage standard one pint, one quart, one gallon, and two gallon food storage and freezer bags.

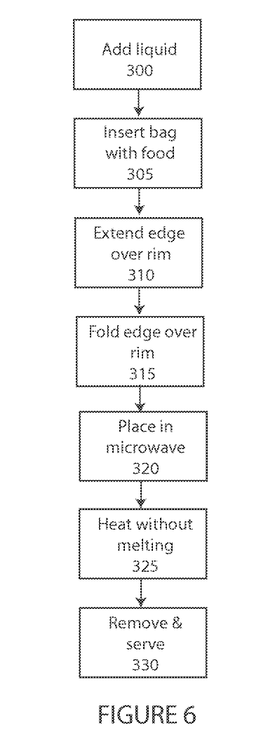

A method of using a holder to re-heat previously cooked food according to principles of the invention is conceptually illustrated in the flowchart of FIG. 6. Before a bag is placed in the holder, the holder is partially filled with a liquid medium. The liquid medium provides thermal regulation. Many food storage bags are made from polyethylene plastic with a softening/melting point of approximately 195° F. The liquid medium may be water or a water-ethanol mixture. Surrounding the bag with such a liquid reduces the risk of melting of the food storage bag during microwave heating.

Alcohol has a lower boiling point than water (about 172° F. for ethanol as compared with 212° F. for water). By diluting water with ethanol, the mixture will have a lower boiling point up until the alcohol completely evaporates. Ethanol, also called ethyl alcohol, pure alcohol, grain alcohol, or drinking alcohol, is a volatile, flammable, colorless liquid that is miscible with water. Because ethanol is miscible with water, the mixture will have a lower boiling point up until all of the mixed liquid evaporates. By adding 10% or more by volume of ethanol (i.e., an “effective amount of ethanol”), the mixture will have a boiling point lower than the melting point of the plastic. Thus, the temperature of the liquid surrounding much of the bag will be lower than the melting point of the bag until liquid evaporates.

Water may be used in lieu of a water-ethanol mixture. Even though the boiling point of water exceeds the melting point of some food storage bags, it has been found that water delays the onset of melting beyond the time necessary to reheat the food. Tests have shown that without water, the food storage bag tends to melt before reheating completes. With water, the food storage bag remains intact throughout food reheating. Melting and boiling do not commence until long after the food has been reheated for normal consumption.

In step 300 the liquid medium (e.g., water or water-ethanol) is introduced into the holder. Typically about a cup of water is used. Although, the volume should and can be adjusted to avoid overflow when the food storage bag containing food is placed in the holder, as in step 305. After the food storage bag is inserted into the cavity, the top edge of the bag is extended above the top rim of the holder, as in step 310. Then the top edge of the bag is folded over the top rim of the holder, as in step 315. The bag may have contained food to be reheated when the bag was inserted into the cavity in step 310. Otherwise, food may be placed into the bag when the bag is in the holder. The food storage bag, liquid and holder are then placed in a microwave oven, as in step 320. The microwave is set to reheat the food, without melting the food storage bag, as in step 325. When reheating is completed, the food is removed and served, as in step 330. Thus, the food is reheated in a microwave oven in the open bag in the holder with a liquid thermal regulation medium, without melting the food storage bag.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A method of reheating food in a food storage bag, said method comprising steps of:
providing a bag holder configured to maintain the food storage bag in an open and upright configuration, said holder comprising a container having an open top and a closed bottom, the open top having a top rim adapted to frictionally engage a folded over top edge of the food storage bag to support it and hold it open, said container further having an interior cavity and said holder being sized to engage the food storage bag; and
pouring a determined amount of a liquid medium into the holder; and
inserting the food storage bag in an open and upright configuration into said holder, said food storage bag having a top edge, and said food storage bag containing food to be reheated, said liquid medium being between the holder and the food storage bag; and
extending the top edge of the food storage bag above the top rim of the holder;
folding the top edge of the food storage bag over the top rim of the holder; and
placing the holder containing the liquid medium and the food storage bag and food in a microwave oven; and
activating the microwave oven to reheat the food.

2. A method of reheating food in a food storage bag according to claim 1, said liquid medium comprising water.

3. A method of reheating food in a food storage bag according to claim 1, said liquid medium comprising water and a liquid with a lower boiling point than water.

4. A method of reheating food in a food storage bag according to claim 1, said liquid medium comprising water and ethanol.

5. A method of reheating food in a food storage bag according to claim 1, said liquid comprising a cup of water.

6. A method of reheating food in a food storage bag according to claim 1, wherein said step of activating the microwave oven to reheat the food comprises activating the microwave oven to reheat the food without boiling the liquid.

7. A method of reheating food in a food storage bag according to claim 1, wherein said step of activating the microwave oven to reheat the food comprises activating the microwave oven to reheat the food without melting the food storage bag.

8. A method of reheating food in a food storage bag according to claim 1, wherein said bag holder and said food storage bag are transparent and said method further comprises a step of viewing the food and liquid while the microwave oven is activated to reheat the food.

9. A method of reheating food in a food storage bag according to claim 1, wherein said bag holder includes an effective amount of a thermochromic additive, said thermochromic additive exhibiting a visible color change when the temperature reaches a determined value below the melting point of the food storage bag, and said method further comprises a step of viewing the holder while the microwave oven is activated to reheat the food.

10. A system for reheating food in a food storage bag in a microwave oven, said system comprising:
a bag holder configured to maintain the food storage bag in an open and upright configuration, said holder comprising a container having an open top and a closed bottom, the open top having a top rim adapted to frictionally engage a folded over top edge of the food storage bag to support it and hold it open, said container further having an interior cavity and said holder being sized to engage the food storage bag; and
said food storage bag having a body, a bottom, a top, a resealable closure with a top edge and a bottom edge attached to the top of the body of the bag, and a height measured from the bottom of the body of the bag to the bottom edge of the resealable closure; and
a determined amount of a liquid medium in the holder; and
the food storage bag inserted in an open and upright configuration into said holder in the liquid medium, and the top edge of the food storage bag being folded over the top rim of the holder, and the bottom of the food storage bag resting on the closed bottom of the bag holder; and
a microwave oven for reheating the food.

11. A system for reheating food in a food storage bag according to claim 10, said liquid medium comprising water.

12. A system for reheating food in a food storage bag according to claim 10, said liquid medium comprising water and a liquid with a lower boiling point than water.

13. A system for reheating food in a food storage bag according to claim 10, said liquid medium comprising water and ethanol.

14. A system for reheating food in a food storage bag according to claim 10, said liquid comprising a cup of water.

15. A system for reheating food in a food storage bag according to claim 10, wherein said step of activating the microwave oven to reheat the food comprises activating the microwave oven to reheat the food without boiling the liquid.

16. A system for reheating food in a food storage bag according to claim 1, wherein said step of activating the microwave oven to reheat the food comprises activating the microwave oven to reheat the food without melting the food storage bag.

17. A system for reheating food in a food storage bag according to claim 10, said liquid comprising a cup of water.

18. A system for reheating food in a food storage bag according to claim 10, the top rim of said bag holder being sized to engage the food storage bag.

19. A system for reheating food in a food storage bag according to claim 10, said bag holder having a height that is less than the height of the food storage bag.
